(19) United States
(12) Patent Application Publication
(10) Pub. No.: US 2004/0102560 A1
(43) Pub. Date: May 27, 2004

(54) Polyamide compositions for molding

(76) Inventor: Masahiro Nozaki, Utsunomiya-shi (JP)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/713,283

(22) Filed: Nov. 14, 2003

Related U.S. Application Data
(63) Continuation of application No. 09/630,462, filed on Aug. 2, 2000.

(30) Foreign Application Priority Data
Aug. 2, 1999 (JP) 11(99) - 219332

(51) Int. Cl. C08K 3/34

(52) U.S. Cl. 524/445

(57) ABSTRACT

The present invention relates to polyamide compositions suitable for molding and containing elastomers and fibrous Wollastonite. Such compositions exhibit a superior balance of properties (enabling strength and impact resistance and low warpage.

### FIELD OF THE INVENTION

This invention relates to polyamide compositions for molding that contain elastomers and fibrous wollastonite, and, in greater detail, it relates to polyamide compositions for molding that provide molded products that have a superior balance of strength and impact resistance, low warpage and superior sliding capacity, with which these superior properties can be maintained in regenerated products in which the sprue and runners generated during injection molding can be reused and which can easily be colored.

### BACKGROUND OF THE INVENTION

It is well known that reinforcing materials and/or filling materials are added to thermoplastic polymers for molding in accordance with the properties that are required by the uses of molded products.

In general, when inorganic filling materials (of which glass fibers, carbon fibers, silica, clay, talc and mica are representative) are used singly or in combination, improvement can be obtained in some of the required properties of molded materials such as rigidity, toughness, surface external appearance, strength, low warpage, dimensional stability and sliding characteristics. On the other hand, there is a tendency for other properties to be impaired. Because shrinkage anisotropy occurs in the molded product that is obtained and because warping becomes a problem due to the direction orientation of the compounded inorganic filling material, previous efforts attempt to compound inorganic filler materials of a low aspect ratio. However, when inorganic filler materials of a low aspect ratio are compounded, the strength and impact resistance of the molded products are markedly lower than when fibrous inorganic filler materials are used. Concentrate on adding impact resistance is improved by adding impact resistance agents to polyamide compositions that have been strengthened by inorganic filling materials.

Attempts have been made to adapt aliphatic polyamides, of which nylon 6 and 66 are representative, to various types of molded products as thermoplastic polymers for molding of superior mechanical strength and heat resistance. However, for some molded products, further improvement in mechanical strength and toughness is desired. Further, from the standpoint of diversification of the uses of molded products, there are many instances in which the final product is to be a colored product so that there is also a need for polyamide compositions for molding in which there is little effect on strength and toughness due to the coloring agents. In addition, polyamide compositions for molding whereby reuse of the sprue and runners generated during injection molding is made possible are desired for the purpose of contribution to decrease in industrial waste products.

In recent years, aromatic polyamides that contain aromatic monomer components in a portion of their structural elements have come into wide use as thermoplastic polymers for molding because of their superior high temperature rigidity, heat resistance, resistance to chemicals and water absorbing capacity. They are particularly suited to molded products that require high heat resistance and dimensional stability under high-temperature, high-humidity conditions.

However, there is a desire for a polyamide composition that can meet the rigorous property requirements for molded products and that, at the same time, is also endowed with superior mechanical strength, toughness, sliding characteristics and wear properties.

An example of compounding various types of inorganic filling materials in thermoplastic polymers is the composition described in Japanese Patent Application Early Disclosure No. 7-149948 [1995]. In this case, a study was made regarding lowering of the coefficient of linear expansion, improving heat resistance due to increasing crystallinity and improving surface external appearance by compounding acicular wollastonite present in natural metamorphic rock (consisting essentially of calcium metasilicate) in the polyamide composition. However, in spite of the fact that it is an aliphatic polyamide and that it is an aromatic polyamide, a molded polyamide composition product was not obtained that can easily be colored, that has a superior balance. Further, a polyamide composition for molding with which these superior characteristics can be maintained even in regenerated products in which sprue and runners that generated during injection molding are reused is not suggested.

It is an object of this invention is to provide a molded product that has a superior balance of strength and impact resistance, low warpage and superior sliding capacity, and, further, to provide a polyamide composition for molding with which these superior characteristics can be maintained both in regenerated products in which the sprue and runners generated during injection are reused or in molded products that are colored by any desired coloring agent and that can be used satisfactorily for furniture parts (such as the legs of chairs) and machine parts (such as gears).

### SUMMARY OF THE INVENTION

It has been discovered that polyamide compositions that satisfy the aforementioned characteristics can be provided by compounding various elastomers and specified wollastonite in specified ratios.

Specifically, the polyamide composition of this invention comprises: A. 10 to 94 weight % of polyamide, (B) 3 to 25 weight % of at least one elastomer selected from the group consisting of (a) an elastomer comprised of ethylene-porpylene-diene, (b) a graft modified elastomer of ethylene-propylene-diene and that has been graft modified, (c) an elastomer of ethylene and an unsaturated carboxylic acid and/or an unsaturated carboxylic acid ester, (d) an ionomer of an elastomer comprised of ethylene and an unsaturated carboxylic acid and/or an unsaturated carboxylic acid ester, (e) a graft modified elastomer comprised of ethylene and an unsaturated carboxylic acid and/or an unsaturated carboxylic acid ester and (f) an ionomer of an elastomer of ethylene and an unsaturated carboxylic acid and/or an unsaturated carboxylic acid ester and that has been graft modified and, (C.) 3 to 65 weight % of wollastonite of a number average length of approximately 5 μm to 180 μm and a number average diameter of approximately 0.1 μm to 15.0 μm and the average aspect ratio of which is greater than 3:1.

### DETAILED DESCRIPTION OF THE INVENTION

### A. Polyamide Resin

The polyamides that are useful in this invention are semicrystalline polyamides or noncrystalline polyamides. They can be a condensates that are obtained by condensing a saturated dicarboxylic acid having 4 to 12 carbon atoms and a diamine having 4 to 14 carbon atoms and they can be random open ring polymers.

Further, the polyamides that are useful in this invention can be compounds of two or more polyamides and they can also be substances in which two or more monomer components are copolymerized.

Specific examples of polyamides that are manufactured by condensation of dicarboxylic acids and diamines include polybutyl methylene adipamide (nylon 46), polyhexamethylene adipamide (nylon 66), polyhexamethylene azelamide (nylon 69), polyhexamethylene sebacamide (nylon 610) and polyhexamethylene dodecanoamide (nylon 612).

Polyamides that are manufactured by condensation of dicarboxylic acids and diamines can also include polyamides that contain aromatic monomers in the monomer component that forms the polyamide. Preferably, they are semi-aromatic polyamides in which the quantity of aromatic monomer is greater than 20 mol % having a melting point of which is greater than 280° C.

Specific examples of aromatic monomers can include aromatic diamines, aromatic carboxylic acids and aromatic aminocarboxylic acids.

Aromatic diamines can include, for example, p-phenylenediamine, o-phenylene-diamine, m-phenylenediamine, p-xylenediamine and m-xylenediamine. Aromatic dicarboxylic acids can include, for example, terephthalic acid, isophthalic acid, phthalic acid, 2-methylterephthalic acid and naphthalenedicarboxylic acid. Aromatic amino-carboxylic acids can include, for example, p-aminobenzoic acid.

Other structural components of the semi-aromatic polyamides are aliphatic dicarboxylic acids, aliphatic alkylenediamines, alicyclic akylenediamines and aliphatic aminocarboxylic acids.

The aliphatic dicarboxylic acid component can be, for example, adipic acid, sebacic acid, azelaic acid and dodecanoic acid. The aliphatic alkylenediamine component can be, for example, ethylenediamine, trimethylenediamine, tetramethylene-diamine, pentamethylenediamine, hexamethylenediamine, 1,7-diaminoheptane, 1,8-diaminooctane, 1,9-diaminononane, 1,10-diaminodecane, 2-methylpentamethylene-diamine and 2-ethyltetramethylenediamine. The alicyclic alkylenediamine component can be, for example, 1,3-diaminocyclohexane, 1,4-diaminocyclohexane, 1,3-bis(amino-methyl)cyclohexane, bis(aminomethyl)cyclohexane), bis(4-aminocyclohexane)methane, 4,4′-diamino-3,3′-dimethyldicyclohexylmethane, isophoronediamine and piperazine. The aliphatic aminocarboxylic acid component can be, for example, 6-aminocaproic acid, 11-aminoundecanoic acid and 12-aminododecanoic acid.

Polyamides that are manufactured by random ring-opening polymerization can include, specifically, polycaprolactam, polylauric lactam, polu-11-aminoundecanoic acid and bis(p-aminocyclohexyl)methane dodecanoamide.

Of these, nylon 6, nylon 66 and aromatic polyamides having melting points greater than 280° C. are particularly desirable.

The polyamides can be compounded on the basis of the total weight of the polyamide, the elastomer and the wollastonite in an amount within the range of 10 to 94 weight percent.

### B. Elastomer

The elastomers that are useful in this invention are one or more of (a) an elastomer comprised of ethylene-propylene-diene, (b) a elastomer of ethylene-propylene-diene graft modified, (c) an elastomer of ethylene and an unsaturated carboxylic acid and/or an unsaturated carboxylic acid ester, (d) an ionomer of an elastomer of ethylene and an unsaturated carboxylic acid and/or an unsaturated carboxylic acid ester, (e) a graft modified elastomer of ethylene and an unsaturated carboxylic acid and/or an unsaturated carboxylic acid ester and (f) an ionomer of an elastomer of ethylene and an unsaturated carboxylic acid and/or an unsaturated carboxylic acid ester that has been graft modified.

The elastomers comprised of ethylene-propylene-diene (a) and the graft modified elastomers (b) thereof can be, for example, ethylene/propylene/1,4-hexadiene-g-maleic anhydride; mixtures of ethylene/propylene/1,4-hexadiene and ethylene/maleic anhydride; mixtures of ethylene/propylene/1,4-hexadiene and ethylene/propylene/1,4-hexadiene-g-maleic anhydride; ethylene/propylene/1,4-hexadiene-g-fumaric acid; ethylene/propylene/1,4-hexadiene/norbomadiene-g-maleic anhydride monoethyl ester; ethylene/propylene/1,4-hexadiene/norbomadiene-g-fumaric acid; mixtures of ethylene/propylene/propylene/1,4hexadiene and ethylene/maleic anhydride monoethyl ester; mixtures of ethylene/propylene/1,4-hexadiene and ethylene/monobutyl maleate; and mixtures of ethylene/propylene/1,4-hexadiene and ethylene/maleic anhydride.

The elastomers (c) and the monomer components (e) that form the graft modified elastomers thereof include, for example, acrylic acid, methacrylic acid or esters thereof. Specifically, they can include ethylene/acrylic acid, ethylene/methacrylic acid, ethylene/n-butyl acrylate/acrylic acid, ethylene/n-butyl acrylate/methacrylic acid, ethylene/isobutyl acrylate/methacrylic acid, ethylene/isobutyl acrylate/acrylic acid, ethylene/n-butyl methacrylate/methacrylic acid, ethylene/methyl methacrylate/acrylic acid, ethylene/methyl acrylate/acrylic acid, ethylene/methyl acrylate/methacrylic acid, ethylene/methyl methacrylate/methacrylic acid and ethylene/n-butyl methacrylate/acrylic acid.

The ionomers (e) of elastomers and ionomers of (f) can be derived by neutralizing with metal ions elastomers comprised of ethylene and unsaturated carboxylic acids and/or unsaturated carboxylic acid esters or elastomers that are of ethylene and unsaturated carboxylic acids and/or unsaturated carboxylic acid esters and that have been graft modified. The metal ions can be monovalent or divalent metal cations. Metal cations that are compatible with polyamides, i.e., cations that act on amide bonds of polyamides, are particularly desirable. The metal ions can be, for example, Na, Zn, Li, Mg and Mn.

One or more of the aforementioned elastomers can be compounded on the basis of the total weight of the polyamide, the elastomer and the wollastonite within a range of 3 to 25 weight percent. It is desirable that the quantity compounded be 5 to 20 weight percent. When the elastomer is present in an amount less than the aforementioned range, sufficient improvement in toughness does not occur. On the other hand, when the elastomer is present in an amount that exceeds the aforementioned range, the flexural modulus is decreased and the elastomer become excessively pliable. This is not desirable.

### C. Wollastonite

The wollastonite useful in this invention is a white mineral that is comprised essentially of calcium metasilicate, which is commonly used as an inorganic filler material of thermoplastic polymer for molding.

Wollastonite is fibrous, its number average length should be in the range of 5 to 180 μm, and, preferably, of 20 to 100 μm, its number average diameter should be 0.1 to 15.0 μm, and, preferably, 2.0 to 7.0 μm, and its average aspect (length and breadth) ratio should be greater than 3:1, preferably in the range of 3:1 to 50:1, and, more preferably, of 5:1 to 30:1. When the number average length, the number average diameter and the average aspect of the wollastonite are not within the specified range of this invention, a molded product having superior strength and sliding characteristics and low warpage cannot be provided.

Wallastonite of this kind is compounded on the basis of the total weight of the polyamide, the elastomer and the wallastonite within a range of 3 to 65 weight percent. It is desirable that the compounding quantity be 5 to 50 weight %.

When glass fibers, which are well known as fibrous inorganic filler materials, are compounded in polyamides in high content, warping of the molded product generally becomes a problem. However, in this invention, molded products of low warpage can be provided in spite of the fact that a fibrous filler material is used in a high content.

It is preferred that the fibrous wollastonite used in this invention be treated with a titanate, silane, zirconate coupling agent or other coupling agents or other surface treatments. It is also preferable that the wollastonite fibers are treated with silane surface treatments by using aminosilane (γ-aminopropyltriethoxysilane) or epoxysilane (γ-glycidxypropylmethoxysilane). The amount of the abovementioned surface treatment agents is about 0.2-2.0 wt % per hundred parts by weight of the wollastonite, more preferably 0.5-1.0 wt %. In a preferred treatment process, the treatment agents are added to the wollastonite fibers followed by heating and drying or untreated wollastonite fibers are mixed with a blend of polyamide resins and the treatment agents with the predetermined amounts by integral blending in preparation of the polyamide composition according to the present invention.

The polyamide composition of this invention may be added to the aforementioned components to an extent that does not impair its characteristics. Additives that are commonly used with polyamides such as thermal stabilizers, antioxidants, weather resistance stabilizers, fire-retarding agents, nucleation agents and mold releasing agents.

The polyamide composition for of this invention can be prepared by fusing and mixing the aforementioned polyamide A, the elastomer B and the wollastonite C, and, further, as desired, necessary additives and/or other resins. There are no particular limitations on the method of preparation. For example, it can be prepared by a method such as compounding and kneading additives and or other resins as desired while the aforementioned polyamide A, elastomer B and wollastonite C are being fused using a kneading device such as a biaxial screw extruding machine. In addition, the polyamide and the elastomer and the polyamide and the wollastonite can be dry blended separately and the compounding substances may be fused and kneaded with a biaxial or monoaxial screw extruding machine. Further, pellets of polyamide and elastomer and pellets of polyamide and wollastonite that have been manufactured with a biaxial screw extruding machine may be dry blended and supplied to the molding machine in which the molded product is molded.

The polyamide composition of this invention can be manufactured into a molded product of the desired shape using a commonly used fusion molding method, for example, the injection molding method, the compression molding method or extrusion a molding method. All as understood by those of skill in the art.

The polyamide composition of this invention can be applied to any number of uses in which superior balance between strength and impact resistance and low warpage are required including furniture components such as legs of chairs and to machine parts such as gears and to uses such as sliding capacity is required, including gears.

### EXAMPLES

The invention will become better understood upon reference to the following examples.

### Examples 1 to 7 and Comparative Examples 1 to 7

The polyamides, elastomers and inorganic filler materials shown in Table 1 were fused and kneaded in a biaxial screw extruding machine and cooled with water, after which pellets were manufactured. Test strips were molded following the test method at a mold temperature of 150° C. using the pellets that were obtained. Tensile strength, tensile breaking elongation, bending strength, flexural modulus, notch Izod impact strength were determined using the molded test strips. Tests strips of 75 mm×125 mm×3.2 mm were molded at a mold temperature of 150° C. using the pellets that were obtained and the molding shrinkage rate was determined. The results are shown in Table 1.

The polyamides, elastomers and inorganic filler materials that were used in the Examples and Comparative Examples were as follows.

### Polyamides

66: Nylon 66, manufactured by the Du Pont Company. Brand name, Zytel [phonetic] 101

6/66: Compound of Nylon 6, manufactured by Ube Kyosan (Ltd.) (brand name, 1015B) and Nylon 66 manufactured by the Du Pont Company (brand name, Zytel 101) Aromatic polyamide: Semi-aromatic polyamide obtained by polymerizing 2-methyl-pentamethylenediamine, hexamethylenediamine and terephthalic acid in proportions of 25 mol %, 25 mol % and 50 mol % (manufactured by the Du Pont Company; brand name: HTN501; melting point, 305° C.; glass transition temperature, 125° C.)

### Elastomer

EPDM: Copolymer of ethylene/propylene/diene monomer (manufactured by the Du Pont Company; brand name, TRX-301)

### Inorganic Filler Materials

Wollastonite A: Fibrous wollastonite (manufactured by Otsuka Chemicals (Ltd.); brand name: Bistal W101)

Number average length: 20 to 35 μm; number average diameter: 2 to 5 μm

Average aspect ratio: 4:1-14:1

Wollastonite B: Fibrous wollastonite (manufactured by the Nyco Company; brand name, Nyad G)

Average length/average diameter: Shows the broad range distribution exceeding the range specified in this invention.

Average aspect ratio: 15:1

Glass fibers: manufactured by the PPG Company; brand name, PP

Number average length: 3 mm; number average diameter: 10 μm

Average aspect ratio: 300:1

### Determination Methods are as Described Below

Tensile strength

Determined in accordance with D638

Tensile breaking elongation

Determined in accordance with D638

Bending strength

Determined in accordance with D790.

Flexural modulus

Determined in accordance with D790-92.

Notch Izod impact strength

Determined in accordance with D256.

Molding shrinkage rate

The test strips were allowed to stand for 48 hours at 23° C. and a relative humidity of 50%, after which determinations were made during molding of the shrinkage rate F in the direction of resin flow and the shrinkage rate V in the direction perpendicular to the resin value. The closer the value of F/V approaches 1, the less warping of the molded product there is.

### Coefficient of Kinetic Friction/Abrasion Loss

Coefficient of kinetic friction of the test bars for tensile test according to ASTM were measured in by actual distance after 1 hour of reciprocating sliding test under the following conditions:

Load: 2 kgf

Distance: 32.5 mm

Time cycle: 1 sec

Subject material: S4

TABLE 1

| | Ex 1 | Ex 2 | Ex 3 | Ex 4 | Ex 5 | Ex 6 | Ex 7 | CmpEx 1 |
|---|---|---|---|---|---|---|---|---|
| Poly-amide | | | | | | | | |
| Type | 6/66 | 66 | ArPyAm | ArPyAm | ArPyAm | ArPyAm | ArPyAm | 6/66 |
| Content | 22.5/22.5 | 55 | 52.1 | 59.6 | 64.6 | 74.6 | 79.6 | 25/25 |
| (wt %) | | | | | | | | |
| Elas-tomer | | | | | | | | |
| Type | EPDM | EPDM | EPDM | EPDM | EPDM | EPDM | EPDM | none |
| Content | 5 | 5 | 7.5 | 10 | 5 | 10 | 10 | 0 |
| (wt %) | | | | | | | | |
| Filler material | | | | | | | | |
| Type | WoA | WoA | WoA | WoA | WoA | WoA | WoA | WoA |
| Content | 50 | 40 | 40 | 30 | 30 | 15 | 10 | 50 |
| (wt %) | | | | | | | | |
| Other additives | | | | | | | | |
| Type | none | None | TS/NA | TS/NA | TS/NA | TS/NA | TS/NA | none |
| Content | 0 | 0 | 0.4 | 0.4 | 0.4 | 0.4 | 0.4 | 0 |
| (wt %) | | | | | | | | |
| Tensile strength (MPa) | 100 | 94 | 106 | 91 | 107 | 83 | 79 | 123 |
| Elongation (%) | 3.8 | 4.3 | 2.8 | 3.8 | 3.3 | 6.4 | 8.7 | 3.2 |
| Bending strength (MPa) | 180 | 172 | 179 | 156 | 182 | 136 | 132 | 218 |
| Flexural modulus (MPa) | 11,562 | 9,200 | 8,511 | 6,073 | 6,965 | 3,712 | 3,900 | 13,523 |
| Notch Izod impact strength | 76 | 80 | 50 | 57 | 39 | 55 | 54 | 45 |
| (J/m) | | | | | | | | |
| Molding contraction ratio: flow | 0.4 | — | 0.4 | 0.4 | 0.4 | 0.7 | — | 0.3 |
| direction (%) | | | | | | | | |
| Molding contraction ratio: | 0.9 | — | 0.8 | 0.9 | 0.8 | 1.0 | — | 0.9 |
| perpendicular direction (%) | | | | | | | | |
| Coefficient of kinetic friction | 0.36 | | 0.36 | | | | | 0.37 |

| | CmpEx 2 | CompEx 6 | CompEx 7 |
|---|---|---|---|
| Poly-amide | | | |
| Type | 6/66 | ArPyAm | 66/6 |
| Content | 25/25 | 59.5 | 33.5/33.5 |
| (wt %) | | | |
| Elas-tomer | | | |
| Type | none | none | None |
| Content | 0 | 0 | 0 |
| (wt %) | | | |
| Filler material | | | |
| Type | Wo B | Wo A | GlFb |
| Content | 50 | 40 | 33 |
| (wt %) | | | |
| Other additives | | | |
| Type | none | TS/NA | None |
| Content | 0 | 0.5 | 0 |
| (wt %) | | | |
| Tensile strength (MPa) | 94 | 140 | 186 |
| Elongation (%) | 2.2 | 1.6 | 3.7 |
| Bending strength (MPa) | 161 | 240 | 280 |
| Flexural modulus (MPa) | 11,424 | 11042 | 8848 |
| Notch Izod impact strength | 36 | 37 | 149 |
| (J/m) | | | |
| Molding contraction ratio: flow | 0.4 | 0.2 | 0.2 |
| direction (%) | | | |
| Molding contraction ratio: | 1.0 | 0.6 | 0.9 |
| perpendicular direction (%) | | | |
| Coefficient of kinetic friction | 0.39 | 0.36 | 0.41- |

ArPyAm = Aromatic polyamide; Wo = wollastonite; GlFb: Glass fibers; TS/NA: thermal stabilizer/nucleation agent.

From Examples 1 to 7 it can be seen that the polyamide compositions of this invention have a superior balance of strength and impact resistance and low warpage. In particular, when Example 1 and Comparative Example 1 and Example 7 and Comparative Example 4 or 5 are compared, it can be seen that the compositions of this invention have a superior balance of strength and impact resistance.

Comparing these results of Example 1 with those in respective Comparative Examples 1, 2 and 7 and 5 and comparing the results of Example 5 with those in respective Comparative Examples 3 and 6, it can be seen that, for the molding shrinkage rate, the ratio of shrinkage rate in the direction of resin flow during molding and of the shrinkage rate in the direction perpendicular to the direction of resin flow was closer to 1 in Example 1 and 5. From this, there were lower warpage and improvement of sliding characteristics with less effect of addition of elastomer in the Examples in which wollastonite fibers are used.

### Example 8 and Comparative Example 8

In order to confirm the effects of coloring agents on the polyamide compositions for molding of this invention, a master batch of TiO₂ prepared so that the TiO₂ content in the molded products would be 0.08 weight % was compounded with the same composition as in Example 2 and glass reinforced nylon 66/6, which is the composition that is commonly used for colored molded products, and test strips were molded in the same way as in Example 2. The physical properties of the tests strips that were obtained were determined and the physical properties maintenance rate (%) for the test strip obtained from the composition not containing TiO2 was found. The results are shown in Table 2.

TABLE 2

| | | | Comparative |
|---|---|---|---|
| | | Example 8 | Example 8 |
| Composition before compounding | | | |
| TiO₂ master batch | | | |
| Polyamide | Type | 66 | 66/6 |
| | Content (wt %) | 55 | 33.5/33.5 |
| Elastomer | Type | EPDM | none |
| | Content (wt %) | 5 | 0 |
| Filler material | Type | Wollastonite A | Glass fibers |
| | Content (wt %) | 40 | 33 |

| | | |
|---|---|---|
| TiO₂ content in molded product | 0.08 | 0.08 |
| Tensile strength maintenance rate (%) | 97 | 86 |
| Elongation maintenance rate (%) | 99 | 70 |
| Bending strength maintenance rate (%) | 98 | 87 |
| Flexural modulus maintenance rate (%) | 93 | 98 |
| Notch Izod impact strength maintenance | 100 | 57 |
| rate (%) | | |

When Example 8 and Example 8 are compared, it can be seen it can be seen that all of the physical properties were better maintained in Example 8. From this, it is evident that the polyamide composition of this invention could maintain superior physical properties even in colored molded products.

### Example 9 and Comparative Example 9

The polyamides, elastomers and inorganic filler materials shown in Table 3 were fused and kneaded in a biaxial screw extruding machine and cooled with water, after which pellets were manufactured. Test strips were molded following the test method at a mold temperature of 150° C. using the pellets that were obtained. The test strips were pulverized to essentially the same size as the pellets and the pulverized material was subjected to injection molding under the same conditions as for molding the test strips, by which means the test strips were regenerated. Tensile strength and notch Izod impact strength were determined using the regenerated test strips. The maintenance rates for the various physical properties of the test strips before pulverization were found. The results are shown in Table 3.

TABLE 3

| | | | Comparative |
|---|---|---|---|
| | | Example 9 | Example 9 |
| Polyamide | Type | 66 | 66/6 |
| | Content (weight %) | 55 | 33.5/33.5 |
| Elastomer | Type | EPDM | none |
| | Content (weight %) | 5 | 0 |
| Filler material | Type | Wollastonite A | Glass fibers |
| | Content (weight %) | 40 | 33 |

| | | |
|---|---|---|
| Tensile strength maintenance rate (%) | 94 | 92 |
| Notch Izod impact strength maintenance | 100 | 82 |
| rate (%) | | |

When Example 9 and Comparative Example 9 are compared, it can be seen that a superior balance of strength and impact resistance is maintained in Example 9. From this, it is evident that superior physical properties can be maintained even in molded products that are used for regeneration.

### Effect of the Invention

The polyamide compositions of this invention can provide molded products that have a superior balance of strength and impact resistance, low warpage and superior sliding characteristics. Further, because these superior physical properties are maintained even in regenerated products made using molded products, a contribution can be made to reducing industrial waste products by regenerating and using the sprue and runners that are generated during injection molding. Moreover, because these superior physical properties can be maintained even in molded products that are colored by any desired coloring agent, colored molded products that have a superior balance between strength and impact strength, low warpage and superior sliding characteristics can be provided using any desired coloring agent.

1. A polyamide composition suitable for molding comprising:
A. 10 to 94 weight % of polyamide,
B. 3 to 25 weight % of at least one elastomer selected from the group consisting of (a) an elastomer comprised of ethylene-propylene-diene, (b) an elastomer comprised of ethylene-propylene-diene and that has been graft modified, (c) an elastomer comprised of ethylene and an unsaturated carboxylic acid and/or an unsaturated carboxylic acid ester, (d) an ionomer of an elastomer comprised of ethylene and an unsaturated carboxylic acid and/or an unsaturated carboxylic acid ester, (e) an elastomer comprised of ethylene and an unsaturated carboxylic acid and/or an unsaturated carboxylic acid ester and that has been graft modified and (f) an ionomer of an elastomer comprised of ethylene and an unsaturated carboxylic acid and/or an unsaturated carboxylic acid ester and that has been graft modified and
C. 3 to 65 weight % of wollastonite of a number average length of approximately 5 μm to 180 μm and a number average diameter of approximately 0.1 μm to 15.0 μm and the average aspect ratio of which is greater than 3:1.

2. The polyamide composition of claim 1 wherein said polyamide (A) is selected from the group consisting of polybutyl methylene adipamide, polyhexamethylene adipamide, polyhexamethylene azelamide, polyhexamethylene sebacamide, and polyhexamethylene dodecanoamide.

3. The polyamide composition of claim 2 further molding aromatic monomer in a amount greater than 20 mol. percent.

4. The composition of claim 3 wherein said aromatic monomer are selected form the group consisting of aromatic diamines, aromatic carboxylic acids, and aromatic aminocarboxylic acids.

5. The composition of claim 1 wherein said Wollastonite (c) has an average output ratio in the range of 5:1 to 30:1.
